(19) United States
(12) Patent Application Publication
(10) Pub. No.: US 2026/0335186 A1
(43) Pub. Date: Oct. 29, 2026

(54) MASSAGE DEVICE CAPABLE OF ADJUSTING PRESSING POSITION IN WIDTH DIRECTION

(71) Applicant: CERAGEM Co., Ltd., Cheonan-si, Chungcheongnam-do (KR)

(72) Inventors: Ho Sang YU, Cheonan-si, Chungcheongnam-do (KR); Jun KIM, Cheonan-si, Chungcheongnam-do (KR); Jung Hoon KIM, Cheonan-si, Chungcheongnam-do (KR); Keun Young PAEK, Cheonan-si, Chungcheongnam-do (KR); Dong Myoung LEE, Asan-si, Chungcheongnam-do (KR); Ki Sung KIM, Cheonan-si, Chungcheongnam-do (KR); Joong Keun AN, Suwon-si, Gyeonggi-do (KR)

(21) Appl. No.: 18/880,074

(22) PCT Filed: May 14, 2024
(86) PCT No.: PCT/KR2024/006611

§ 371 Date: Dec. 30, 2024

(30) Foreign Application Priority Data
May 18, 2023 (KR) 10-2023-0064542

(51) Int. Cl. A61H 39/04; A61H 15/00; A61H 15/02

(52) U.S. Cl. CPC A61H 39/04; A61H 15/0078; A61H 15/02; A61H 2015/0021; A61H 2201/0192; A61H 2201/0207; A61H 2201/1215; A61H 2201/123; A61H 2201/5064

(57) ABSTRACT

Disclosed is a massage device. A massage device in which a pressing position is adjustable in a width direction according to one aspect of the present invention may include a plurality of pressing members disposed to press one side and the other side of the spine of a user in the width direction, and an interval adjusting member configured to adjust a distance between the pressing members in the width direction.

### TECHNICAL FIELD

The present invention relates to a massage device, and more particularly, to a massage device in which a massage position is adjustable in a width direction.

### BACKGROUND ART

Conventionally, a spinal thermal massage device that enhances blood flow by moving along a body part and applying stimulation using warmth to a pain site is widely used in order to alleviate acute or chronic pain in muscles and nervous tissues of the spine occurring due to working with bad posture for a long time or such posture becoming a habit, enhance blood circulation in the body, or address instant muscle stiffness.

In such a spinal thermal massage device, acupressure tools are provided to apply stimulation using warmth to a user while pressing the user, and the acupressure tools are provided at one side and the other side in a width direction about the spine of the user.

However, since a distance between the acupressure tools in the width direction is fixed to be constant, the conventional spinal thermal massage device is suitable for pressing a part with a relatively wide interval in the width direction such as the thoracic spine or the lumbar spine but is not suitable for pressing a part with a narrow interval in the width direction such as the cervical spine, and thus there is a problem in that effects of the thermal massage decrease.

Therefore, there is a need for development of technology that can address the above problem.

### DISCLOSURE

### Technical Tasks

The present invention is directed to providing a massage device in which a pressing position is adjustable in a width direction that allows thermal massage to be effectively performed for a part with a narrow interval in the width direction such as the cervical spine as well as a part with a wide interval in the width direction such as the thoracic spine or the lumbar spine.

Objectives of the present invention are not limited to the above-mentioned objective, and other unmentioned objectives should be clearly understood by those of ordinary skill in the art to which the present invention pertains from the description below.

### Technical Solution

One aspect of the present invention provides a massage device in which a pressing position is adjustable in a width direction, the massage device including a plurality of pressing members disposed to press one side and the other side of the spine of a user in the width direction, and an interval adjusting member configured to adjust a distance between the pressing members in the width direction.

Here, the massage device may further include a frame member configured to provide support so that the pressing members are rotatable about a rotation axis disposed in the width direction, and the interval adjusting member may move the frame member in the width direction.

Here, the interval adjusting member may include a rotary plate and a support shaft connected to the frame member and disposed at a position eccentric from a center of the rotary plate.

Here, the massage device may further include a fastening member fixed to the support shaft through the frame member, a through-hole through which the fastening member passes may be provided in the frame member, and an inner surface of the through-hole may be disposed apart from an outer surface of the fastening member.

Here, an extension guide extending to surround the support shaft may be provided at the frame member, and an inner surface of the extension guide may be disposed apart from an outer surface of the support shaft.

Here, each of the pressing members may have acupressure surfaces provided on at least two or more positions in the width direction to press the user, and the massage device may further include an aligning member configured to maintain a constant arrangement state of the acupressure surfaces.

Here, the aligning member may support the frame member so that a constant arrangement state of the rotation axis is maintained.

Here, the aligning member may include a first support frame connected to the frame member disposed at one side in the width direction, a second support frame connected to the frame member disposed at the other side in the width direction, and a sliding bar configured to provide a path for the first support frame and the second support frame to move in the width direction.

Here, one side of the sliding bar in the width direction may be fixed to the first support frame, and the other side of the sliding bar in the width direction may be disposed to be slidable while passing through the second support frame.

Here, the first support frame may include a first support housing in which a first connecting bar integrally formed with the frame member is disposed, and the one side of the sliding bar in the width direction may be fixed to the first connecting bar.

Here, the second support frame may include a second support housing in which a second connecting bar integrally formed with the frame member is disposed, and the other side of the sliding bar in the width direction may be slidably connected to the second connecting bar.

Here, the second support frame may further include a sliding frame disposed inside the second connecting bar to slidably support the sliding bar and having a guide surface provided to extend in the width direction of the sliding bar.

Here, an expansion guide surface extending from the guide surface to support the sliding bar from outside the second support housing may be provided on the sliding frame.

Here, a first support member configured to support the user's body may be provided at an inner side of the frame member in the width direction.

Here, an auxiliary pressing member configured to press the user's body may be provided at an inner side of the frame member in the width direction.

Here, the pressing members may include first acupressure tools and second acupressure tools sequentially arranged in a longitudinal direction, a distance between the first acupressure tools in the width direction may be adjusted by the interval adjusting member, and a distance between the second acupressure tools in the width direction may be fixed.

Here, the massage device may further include a pressing plate member on which the pressing members are disposed, and the pressing plate member may include a first unit plate on which the first acupressure tools are disposed and a second unit plate on which the second acupressure tools are disposed and which is fixed to the first unit plate.

Here, the massage device may further include a hinge member configured to hinge and fix a rear of the pressing plate member in the longitudinal direction.

Here, a second support member configured to support the user's body may be provided on an upper surface of the first unit plate.

Here, a curved surface having a predetermined curvature to support the user's body may be provided on the first unit plate.

Here, the massage device may further include a detector configured to detect positions of the pressing members in the width direction and a controller configured to control an operation of the interval adjusting member based on a signal sent from the detector.

Here, the massage device may further include a lifting/lowering portion on which a lifting/lowering member configured to lift or lower the pressing members and a lifting/lowering driving member configured to provide a driving force of the lifting/lowering member are provided, and a conveying portion on which a conveying plate member on which the pressing members and the lifting/lowering portion are disposed and a conveying driving member configured to provide a driving force for the conveying plate member to move in the longitudinal direction are provided.

### Advantageous Effects

According to the above configuration, in a massage device in which a pressing position is adjustable in a width direction according to one aspect of the present invention, since a distance in the width direction between a pair of pressing members disposed to press one side and the other side of the spine of a user in the width direction can be adjusted using an interval adjusting member, effective thermal massage is possible for a part with a narrow interval in the width direction such as the cervical spine as well as a part with a wide interval in the width direction such as the thoracic spine or the lumbar spine, and user satisfaction can be improved.

Advantageous effects of the present invention are not limited to those mentioned above and should be understood as including all advantageous effects inferable from the detailed description of the present invention or the configuration of the invention stated in the claims.

### DESCRIPTION OF DRAWINGS

FIG. 1 is a perspective view illustrating a massage device in which a pressing position is adjustable in a width direction according to one embodiment of the present invention.

FIG. 2 is a cross-sectional view illustrating the massage device in which a pressing position is adjustable in the width direction according to one embodiment of the present invention.

FIG. 3 is a front view illustrating an enlarged view of a pressing member provided in the massage device in which a pressing position is adjustable in the width direction according to one embodiment of the present invention.

FIG. 4 is a cross-sectional view of the pressing member provided in the massage device in which a pressing position is adjustable in the width direction according to one embodiment of the present invention.

FIG. 5 is a cross-sectional view illustrating an enlarged view of portion A of FIG. 4.

FIG. 6 is a plan view illustrating an aligning member provided in the massage device in which a pressing position is adjustable in the width direction according to one embodiment of the present invention.

FIG. 7 is a front view illustrating the aligning member provided in the massage device in which a pressing position is adjustable in the width direction according to one embodiment of the present invention.

FIG. 8 is a cross-sectional view illustrating the aligning member provided in the massage device in which a pressing position is adjustable in the width direction according to one embodiment of the present invention.

FIG. 9 is a perspective view illustrating a massage device in which a pressing position is adjustable in a width direction according to another embodiment of the present invention.

FIG. 10 is a perspective view illustrating a massage device in which a pressing position is adjustable in a width direction according to still another embodiment of the present invention.

### MODES OF THE INVENTION

Hereinafter, embodiments of the present invention will be described in detail with reference to the accompanying drawings so that those of ordinary skill in the art to which the present invention pertains can easily carry out the present invention. The present invention may be implemented in various different forms and is not limited to the embodiments described herein. In the drawings, in order to clearly describe the present invention, parts irrelevant to the description are omitted, and like or similar components are denoted by like reference numerals throughout the specification.

Words or terms used in the present specification and the claims should not be interpreted as being limited to their general or dictionary meanings and should be interpreted to have meanings and concepts consistent with the technical spirit of the present invention, according to the principle that the inventor may define terms and concepts thereof in order to describe his or her invention in the best possible way.

Therefore, the embodiments described in the present specification and the configurations illustrated in the drawings are only exemplary embodiments of the present invention and do not represent the entire technical spirit of the present invention, and thus various equivalents and modifications that can replace the embodiments may be present at the time of filing this application.

In the present specification, terms such as “include” or “have” are intended to designate the presence of features, numbers, steps, operations, components, parts, or combinations thereof described herein and should not be understood as precluding the possibility of presence or addition of one or more other features, numbers, steps, operations, components, parts, or combinations thereof.

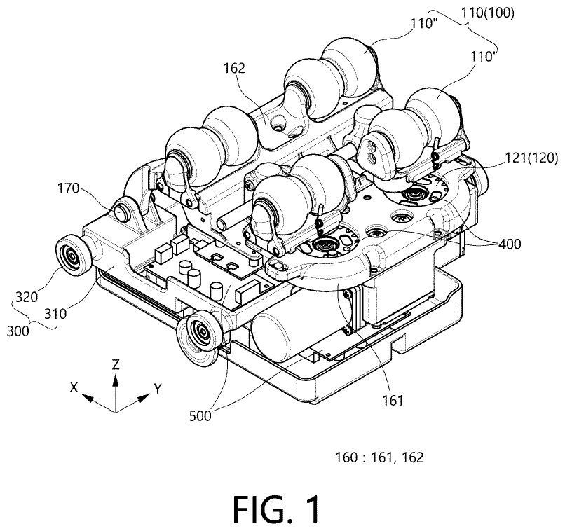

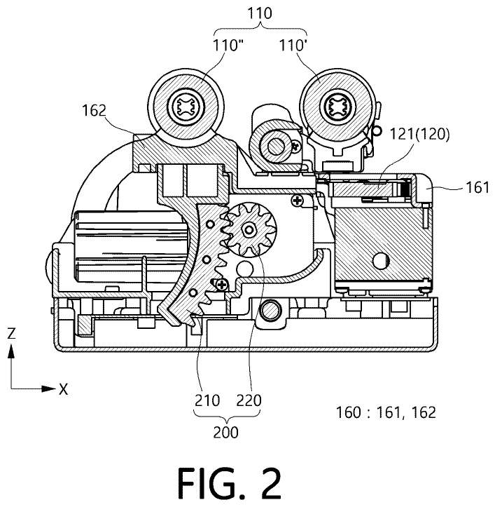

FIG. 1 is a perspective view illustrating a massage device in which a pressing position is adjustable in a width direction according to one embodiment of the present invention, and FIG. 2 is a cross-sectional view illustrating the massage device in which a pressing position is adjustable in the width direction according to one embodiment of the present invention. Here, the X-direction is a longitudinal direction (a direction identical to the direction in which the user's spine is arranged), the Y-direction is a width direction and is divided into one side and the other side of the user's spine in the width direction, and the Z-direction is a height direction and is a direction in which a pressing member moves upward or downward to adjust a degree to which the user's body is pressed.

As illustrated in FIGS. 1 and 2, a massage device in which a pressing position is adjustable in the width direction according to one embodiment of the present invention includes a plurality of pressing members 110 disposed to press one side and the other side of the spine of a user in the width direction (Y), and an interval adjusting member 120 configured to adjust a distance between the pressing members 110 in the width direction (Y).

Here, a pressing portion 100 may include the pressing members 110.

The massage device may be disposed to be inserted into a pad supporting the user's body, and the massage device presses the user's body while moving in the longitudinal direction (X) in a state in which the massage device is disposed to be inserted into the pad.

The pad may be provided at a main body portion supporting the user's upper body, and an auxiliary portion supporting the user's lower body may be connected to the main body portion. Here, the main body portion may be configured to support the user's buttocks as well as the upper body, and the auxiliary portion may be configured to support only the legs of the user.

Here, the pad may also be provided at the auxiliary portion supporting the user's lower body, and the pad may be configured to be provided at both the main body portion and the auxiliary portion.

A separate leg member may be provided at the main body portion, at which the pad is provided, so that an upper surface of the pad is disposed apart from the ground, and in this way, the user may receive massage in a comfortable posture.

The leg member may be manufactured in a substantially quadrangular band shape. That is, the leg member may include a side frame that corresponds to a side surface of the main body portion, a lower frame supported by the ground, and a connecting frame connecting the side frame and the lower frame. The frames may be integrally manufactured or may be separately manufactured and then combined. Here, the side frame may be manufactured in a plate shape, and the lower frame may be manufactured in a rod shape.

A guide groove may be formed in the above-described main body portion, and a guide protrusion inserted into the guide groove may be formed on the auxiliary portion so that the auxiliary portion is configured to be slidable. Alternatively, a guide groove may be formed in the auxiliary portion, and a guide protrusion may be formed on the main body portion so that the auxiliary portion is configured to be slidable.

As illustrated in FIG. 1, a separate heating member may be provided on the pressing members 110 to provide a thermal massage effect to the user. Since the pressing members 110 are disposed to press one side and the other side of the user's spine in the width direction (Y), a massage effect may be provided by pressing acupuncture points located on both sides along the user's spine (for example, bladder meridian acupuncture points).

Here, the massage device may further include a lifting/lowering portion 200 on which a lifting/lowering member 210 configured to lift or lower the pressing members 110 and a lifting/lowering driving member 220 configured to provide a driving force of the lifting/lowering member 210 are provided, and a conveying portion 300 on which a conveying plate member 310 on which the pressing members 110 and the lifting/lowering portion 200 are disposed and a conveying driving member 320 configured to provide a driving force for the conveying plate member 310 to move in the longitudinal direction (X) are provided.

As illustrated in FIG. 2, the lifting/lowering member 210 may be a rack gear lifting or lowering the pressing members 110, the lifting/lowering driving member may be a driving motor for providing a driving force, and a pinion gear connected to a driving shaft may be provided at the driving motor. The rack gear moves upward or downward when the pinion gear rotates in one direction or the other direction according to the rotation of the driving shaft.

As illustrated in FIG. 1, the conveying plate member 310 that is plate-shaped and has the pressing members 110 and the lifting/lowering portion 200 disposed thereon may be provided at the conveying portion 300, and a base rib may be provided at both ends of the conveying plate member 310 in the width direction (Y). The conveying driving member 320 may be provided at the base rib, and a support roller may be provided at the conveying driving member 320 and disposed to be movable along a guide rail disposed in the longitudinal direction (X). Also, a separate conveying motor providing a driving force for the support roller to move along the guide rail may be provided at the conveying driving member 320.

Here, as illustrated in FIG. 1, the interval adjusting member 120 adjusting the distance between the pressing members 110 in the width direction (Y) may be provided in the massage device. When the distance between the pressing members 110 in the width direction (Y) is configured to be adjustable in this way, effective thermal massage is possible for a part with a narrow interval in the width direction such as the cervical spine as well as a part with a wide interval in the width direction such as the thoracic spine or the lumbar spine, and user satisfaction is improved.

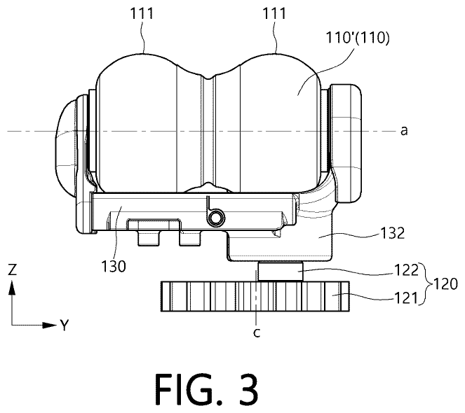

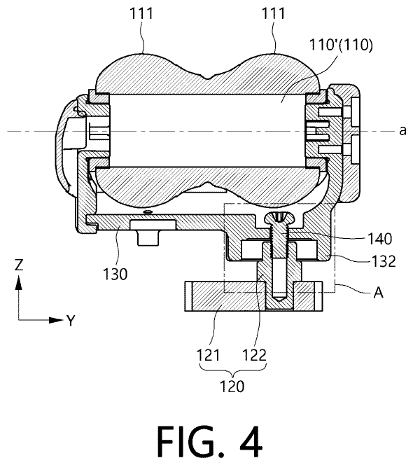

FIG. 3 is a front view illustrating an enlarged view of a pressing member provided in the massage device in which a pressing position is adjustable in the width direction according to one embodiment of the present invention, and FIG. 4 is a cross-sectional view of the pressing member provided in the massage device in which a pressing position is adjustable in the width direction according to one embodiment of the present invention.

As illustrated in FIGS. 3 and 4, the massage device may further include a frame member 130 configured to provide support so that the pressing member 110 is rotatable about a rotation axis a disposed in the width direction (Y), and the interval adjusting member 120 may move the frame member 130 in the width direction (Y).

A pair of support arms may be provided at the frame member 130 to support both sides of the pressing member 110 in the width direction (Y), and a separate bush may be provided at the support arms for the pressing member 110 to be configured to be rotatable about the rotation axis a. Here, the support arm disposed at one side in the width direction (Y) may be integrally formed with the frame member 130, and the support arm disposed at the other side in the width direction (Y) may be configured to be separable. In this way, the pressing member 110 may be easily installed by first installing the pressing member 110 at the support arm disposed at the one side in the width direction (Y) in a state in which the support arm disposed at the other side in the width direction (Y) is separated and coupling a support arm to the other side of the pressing member 110 in the width direction (Y).

Also, since the interval adjusting member 120 is configured to move the frame member 130 in the width direction (Y), the pressing member 110 is able to move in the width direction (Y) while smoothly rotating, and thus operational stability can be secured.

As illustrated in FIG. 3, the interval adjusting member 120 may include a rotary plate 121 and a support shaft 122 connected to the frame member 130 and disposed at a position eccentric from a center c of the rotary plate 121. Here, the support shaft 122 may be configured to be disposed at the center c of the rotary plate 121.

That is, since the support shaft 122 to which the frame member 130 is connected is disposed at the position eccentric from the center c of the rotary plate 121, when the rotary plate 121 rotates, the frame member 130 also moves while drawing a circular trajectory. A separate rotating shaft disposed in the height direction (Z) may be provided at the center c of the rotary plate 121 for smooth rotation of the rotary plate 121. Here, since the circular trajectory drawn by the frame member 130 moves in the width direction (Y) as well as the longitudinal direction (X), effective thermal massage becomes possible for a part with a narrow interval in the width direction such as the cervical spine as well as a part with a wide interval in the width direction such as the thoracic spine or the lumbar spine.

Here, preferably, the support shaft 122 may be connected to an inner side of the frame member 130 in the width direction (Y). In this way, a distance at which the frame member 130 moves in the width direction (Y) increases in the process in which the rotary plate 121 rotates, and thus effective thermal massage becomes possible for a wide part such as the thoracic spine or the lumbar spine, and even when the frame member 130 moves inward in the width direction (Y) to perform thermal massage on the cervical spine, interference between the support shaft 122 and the frame member 130 may be effectively prevented.

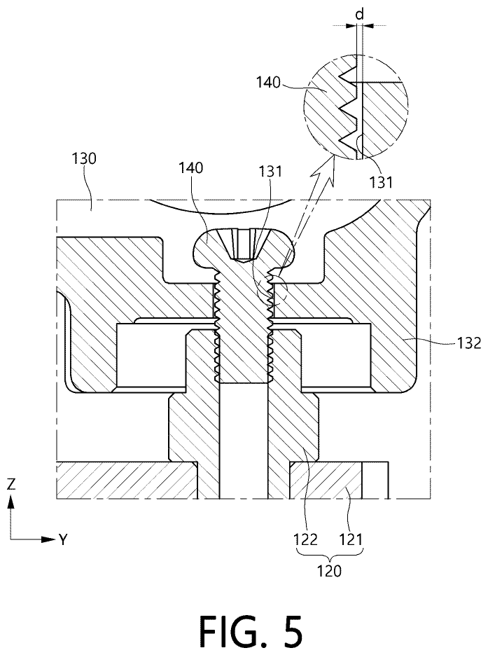

FIG. 5 is a cross-sectional view illustrating an enlarged view of portion A of FIG. 4.

As illustrated in FIG. 5, the massage device may further include a fastening member 140 fixed to the support shaft 122 through the frame member 130, a through-hole 131 through which the fastening member 140 passes may be provided in the frame member 130, an inner surface of the through-hole 131 may be disposed apart from an outer surface of the fastening member 140, and a gap d may be formed between the inner surface of the through-hole 131 and the outer surface of the fastening member 140.

The frame member 130 may be stably fixed to the support shaft 122 through the fastening member 140. Also, since the inner surface of the through-hole 131 through which the fastening member 140 passes and the outer surface of the fastening member 140 are disposed apart from each other, even when the support shaft 122 rotates along with the rotary plate 121, the frame member 130 is able to rotate relative thereto, and thus a state in which the rotation axis a of the pressing member 110 is maintained parallel to the width direction (Y) can be constantly maintained, which enables effective thermal massage.

As illustrated in FIG. 5, an extension guide 132 extending to surround the support shaft 122 may be provided at the frame member 130, and an inner surface of the extension guide 132 may be disposed apart from an outer surface of the support shaft 122.

Since the extension guide 132 extends downward in the height direction (Z) from the frame member 130 to protect a coupling portion between the fastening member 140 and the support shaft 122, and the inner surface of the extension guide 132 is disposed apart from the outer surface of the support shaft 122, even when the support shaft 122 rotates along with the rotary plate 121, the extension guide 132 is able to rotate relative thereto, and thus a state in which the rotation axis a of the pressing member 110 is maintained parallel to the width direction (Y) can be constantly maintained, which enables effective thermal massage.

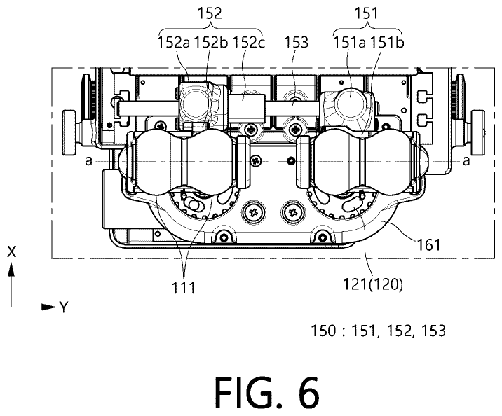

FIG. 6 is a plan view illustrating an aligning member provided in the massage device in which a pressing position is adjustable in the width direction according to one embodiment of the present invention.

As illustrated in FIG. 6, each of the pressing members 110 may have acupressure surfaces 111 provided on at least two or more positions in the width direction (Y) to press the user, and the massage device may further include an aligning member 150 configured to maintain a constant arrangement state of the acupressure surfaces 111.

That is, the pressing members 110 are disposed at one side and the other side of the user's spine in the width direction (Y) to press acupuncture points located on both sides along the user's spine. The above-described acupressure surfaces 111 may be formed to extend along the circumference of the pressing members 110. In this way, even when the pressing members 110 rotate about the rotation axis a while moving in the longitudinal direction (X) in a state in which the user's body is pressed by the pressing members 110, the user's body may be continuously pressed.

Here, one of the two or more positions may be an acupuncture point disposed at a part spaced about 4.5 cm from the user's spine (spine second line, an acupuncture point for treating a bowel-related symptom of the body), and another may be an acupuncture point disposed at a part spaced about 9 cm from the user's spine (spine third line, an acupuncture point for treating a bowel-related chronic symptom of the body and treating a mental symptom). That is, maintaining the constant arrangement state of the acupressure surfaces 111 is important for the pressing members 110 to simultaneously press the two or more acupuncture points while moving in the longitudinal direction (X), and since the constant arrangement state of the acupressure surfaces 111 can be maintained when the aligning member 150 is provided as described above, a thermal massage effect is improved.

As illustrated in FIG. 6, the aligning member 150 may support the frame member 130 so that a constant arrangement state of the rotation axis a is maintained. That is, since the aligning member 150 maintains the constant arrangement state of the rotation axis a while supporting the frame member 130, even when the pressing members 110 move in the width direction (Y) while smoothly rotating, the constant arrangement state of the rotation axis a is maintained, and thus operational stability can be secured.

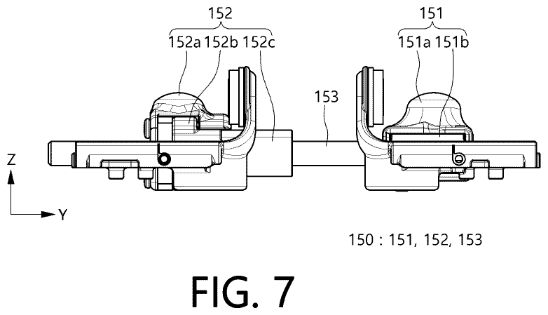

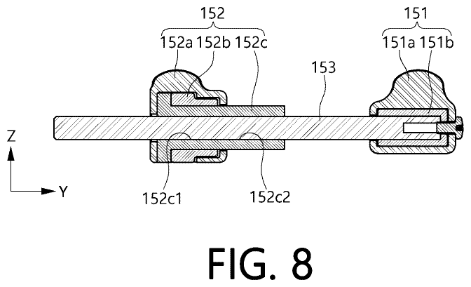

FIG. 7 is a front view illustrating the aligning member provided in the massage device in which a pressing position is adjustable in the width direction according to one embodiment of the present invention, and FIG. 8 is a cross-sectional view illustrating the aligning member provided in the massage device in which a pressing position is adjustable in the width direction according to one embodiment of the present invention.

As illustrated in FIGS. 7 and 8, the aligning member 150 may include a first support frame 151 connected to the frame member 130 disposed at one side in the width direction (Y), a second support frame 152 connected to the frame member 130 disposed at the other side in the width direction (Y), and a sliding bar 153 configured to provide a path for the first support frame 151 and the second support frame 152 to move in the width direction (Y).

The first support frame 151 and the second support frame 152 may be integrally formed with the frame member 130, but the present invention is not necessarily limited thereto, and each of the first support frame 151 and the second support frame 152 may be separately manufactured and then fastened to the frame member 130.

Also, since the sliding bar 153 is formed to extend in the width direction (Y) and provides a path for the first support frame 151 and the second support frame 152 to move in the width direction (Y), even when an interval between the pressing members 110 is adjusted while a circular trajectory is drawn by the pressing members 110, a constant state in which the rotation axis a of the pressing members 110 is arranged in the width direction (Y) may be maintained.

As illustrated in FIG. 8, one side of the sliding bar 153 in the width direction (Y) may be fixed to the first support frame 151, and the other side of the sliding bar 153 in the width direction (Y) may be disposed to be slidable while passing through the second support frame 152.

That is, since the one side of the sliding bar 153 in the width direction (Y) is fixed to the first support frame 151, arbitrary detachment of the sliding bar 153 may be prevented. A separate fastening member such as a screw may be used to fix the one side of the sliding bar 153 in the width direction (Y). Here, the other side of the sliding bar 153 in the width direction (Y) is disposed to be slidable while passing through the second support frame 152, and it is important to form the sliding bar 153 with a sufficient length so that a state in which the other side of the sliding bar 153 passes through the second support frame 152 is maintained even in a state in which the pressing members 110 are distant at the largest possible interval in the width direction (Y).

As illustrated in FIG. 8, the first support frame 151 may include a first support housing 151a in which a first connecting bar 151b integrally formed with the frame member 130 is disposed, and the one side of the sliding bar 153 in the width direction (Y) may be fixed to the first connecting bar 151b.

That is, since, in a state in which the frame member 130 is integrally formed with the first connecting bar 151b disposed in the first support housing 151a, the one side of the sliding bar 153 in the width direction (Y) is fixed to the first connecting bar 151b, stable fixing is possible even in a state in which movement of the pressing members 110 occurs in the width direction (Y).

As illustrated in FIG. 8, the second support frame 152 may include a second support housing 152a in which a second connecting bar 152b integrally formed with the frame member 130 is disposed, and the other side of the sliding bar 153 in the width direction (Y) may be slidably connected to the second connecting bar 152b.

That is, since, in a state in which the frame member 130 is integrally formed with the second connecting bar 152b disposed in the second support housing 152a, the other side of the sliding bar 153 in the width direction (Y) is slidably connected to the second connecting bar 152b, stable sliding is possible even in a state in which movement of the pressing members 110 occurs in the width direction (Y).

As illustrated in FIG. 8, the second support frame 152 may further include a sliding frame 152c disposed inside the second connecting bar 152b to slidably support the sliding bar 153 and having a guide surface 152cl provided to extend in the width direction (Y) of the sliding bar 153.

When the guide surface 152cl extending in the width direction (Y) of the sliding bar 153 is provided on the sliding frame 152c in this way, not only is the sliding bar 153 slidable, but also the arrangement state of the rotation axis a of the pressing members 110 can be stably maintained.

As illustrated in FIG. 8, an expansion guide surface 152c2 extending from the guide surface 152cl to support the sliding bar 153 from outside the second support housing 152a may be provided on the sliding frame 152c.

As described above, the guide surface 152cl extending in the width direction (Y) of the sliding bar 153 is provided on the sliding frame 152c, and when the expansion guide surface 152c2 extending from the guide surface 152cl to support the sliding bar 153 from outside the second support housing 152a is provided on the sliding frame 152c, the arrangement state of the rotation axis a of the pressing members 110 can be more stably maintained.

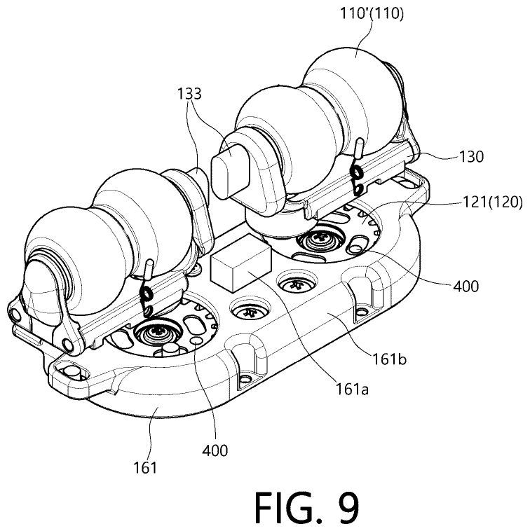

FIG. 9 is a perspective view illustrating a massage device in which a pressing position is adjustable in a width direction according to another embodiment of the present invention.

As illustrated in FIG. 9, a first support member 133 configured to support the user's body may be provided at an inner side of each frame member 130 in the width direction (Y). When the frame members 130 move outward in the width direction (Y) and a distance between the frame members 130 increases, the user's body, in particular the neck, may slip through the frame members 130, and when the distance between the frame members 130 decreases again in this state, the user may feel pain as the user's body is pressed by the frame members 130. Therefore, when the first support member 133 configured to support the user's body is provided at the inner side of each frame member 130 in the width direction (Y) as described above, even when the distance between the frame members 130 increases, the user's body can be prevented from slipping through, and even when an interval between the frame members 130 is adjusted, pain caused due to the user's body being pressed can be effectively prevented.

For example, the first support member 133 may be made of a synthetic resin material such as rubber, but the present invention is not necessarily limited thereto, and any other material may be used as long as the position of the material in the height direction (Z) can be fixed to prevent the user's body from slipping through.

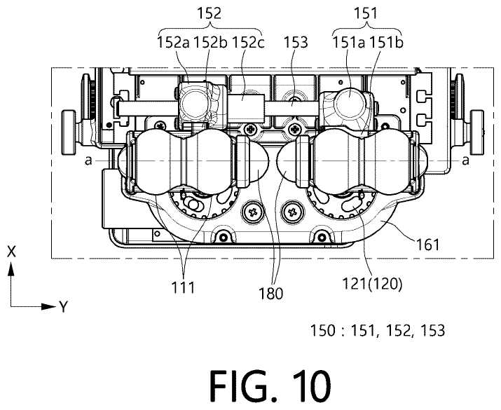

FIG. 10 is a perspective view illustrating a massage device in which a pressing position is adjustable in a width direction according to still another embodiment of the present invention.

As illustrated in FIG. 10, an auxiliary pressing member 180 configured to press the user's body may be provided at an inner side of each frame member 130 in the width direction (Y). The auxiliary pressing member 180 may additionally press and massage the user's body, in particular the neck, in a process in which an interval between the frame members 130 decreases in the width direction (Y). For example, the auxiliary pressing member 180 may be dome-shaped, but the present invention is not necessarily limited thereto, and the auxiliary pressing member 180 may have any other shape as long as the shape is curved to press the user's body in the process in which the interval between the frame members 130 decreases in the width direction (Y). The auxiliary pressing member 180 may be made of a foam material or any other material that can perform acupressure.

As illustrated in FIGS. 1 and 2, the pressing members 110 may include first acupressure tools 110′ and second acupressure tools 110″ sequentially arranged in the longitudinal direction (X), a distance between the first acupressure tools 110′ in the width direction (Y) may be adjusted by the interval adjusting member 120, and a distance between the second acupressure tools 110″ in the width direction (Y) may be fixed.

When the first acupressure tools 110′ between which the distance in the width direction (Y) is adjusted by the interval adjusting member 120 and the second acupressure tools 110″ between which the distance in the width direction (Y) is fixed are sequentially arranged in the longitudinal direction (X) as described above, since it is possible to perform thermal massage on the thoracic spine using the second acupressure tools 110″ while performing thermal massage on the cervical spine using the first acupressure tools 110′, effective thermal massage is possible.

As illustrated in FIGS. 1 and 2, the massage device may further include a pressing plate member 160 on which the pressing members 110 are disposed, and the pressing plate member 160 may include a first unit plate 161 on which the first acupressure tools 110′ are disposed and a second unit plate 162 on which the second acupressure tools 110″ are disposed and which is fixed to the first unit plate 161.

In a state in which the pressing members 110 are disposed on the pressing plate member 160 as described above, when the pressing plate member 160 is lifted or lowered in a state in which the lifting/lowering portion 200 is connected to a lower surface of the pressing plate member 160, stable lifting or lowering of the pressing members 110 is possible, and the lifting/lowering portion 200 may be easily connected to the pressing plate member 160.

Also, manufacturability is improved when the first acupressure tools 110′ are modularized by being installed on the first unit plate 161, the second acupressure tools 110″ are modularized by being installed on the second unit plate 162, and then the first unit plate 161 and the second unit plate 162 are fixed.

As illustrated in FIG. 1, the massage device may further include a hinge member 170 configured to hinge and fix a rear of the pressing plate member 160 in the longitudinal direction (X). Here, the hinge member 170 may be provided at the conveying portion 300.

As described above, the rear of the pressing plate member 160, on which the pressing members 110 are disposed, in the longitudinal direction (X) is configured to be hinged and fixed by the hinge member 170. That is, the pressing members 110 move upward when the pressing plate member 160 moves upward through the operation of the lifting/lowering portion 200, and since the pressing plate member 160 is hinged and fixed, as the pressing members 110 move upward while drawing a circular arc, an effect of pressing in the height direction (Z) and an effect of pushing in the longitudinal direction (X) can be provided in combination, and thus a thermal massage effect can be improved. Here, a rear of the second unit plate 162 in the longitudinal direction (X) may be configured to be hinged and fixed by the hinge member 170 in a state in which the first acupressure tools 110′ are disposed on the first unit plate 161, and the second acupressure tools 110″ are disposed on the second unit plate 162. That is, the first acupressure tools 110′ and the second acupressure tools 110″ move upward when at least any one of the first unit plate 161 and the second unit plate 162 moves upward through the operation of the lifting/lowering portion 200, and since the second unit plate 162 is hinged and fixed, as the first acupressure tools 110′ and the second acupressure tools 110″ move upward while drawing a circular arc, an effect of pressing in the height direction (Z) and an effect of pushing in the longitudinal direction (X) can be provided in combination, and thus a thermal massage effect can be improved.

Alternatively, the hinge member 170 may include a first hinge member configured to hinge and fix a rear of the first unit plate 161 in the longitudinal direction (X) and a second hinge member configured to fix the rear of the second unit plate 162 in the longitudinal direction (X). The first unit plate 161 and the second unit plate 162 are configured to be able to move upward or downward independently from each other. That is, only the first unit plate 161 may move upward or downward, only the second unit plate 162 may move upward or downward, or the first unit plate 161 and the second unit plate 162 may simultaneously move upward or downward.

Here, the lifting/lowering portion 200 may include a first lifting/lowering portion configured to lift or lower the first unit plate 161 and a second lifting/lowering portion configured to lift or lower the second unit plate 162. That is, the first acupressure tools 110′ move upward when the first unit plate 161 moves upward through the operation of the first lifting/lowering portion, and since the first unit plate 161 is hinged and fixed, as the first acupressure tools 110′ move upward while drawing a circular arc, an effect of pressing in the height direction (Z) and an effect of pushing in the longitudinal direction (X) can be provided in combination, and thus a thermal massage effect can be improved. Also, the second acupressure tools 110″ move upward when the second unit plate 162 moves upward through the operation of the second lifting/lowering portion, and since the second unit plate 162 is hinged and fixed, as the second acupressure tools 110″ move upward while drawing a circular arc, an effect of pressing in the height direction (Z) and an effect of pushing in the longitudinal direction (X) can be provided in combination, and thus a thermal massage effect can be improved. Further, various thermal massage effects can be provided through independent upward or downward movement of the first acupressure tools 110′ and the second acupressure tools 110″.

As illustrated in FIG. 9, a second support member 161a configured to support the user's body may be provided on an upper surface of the first unit plate 161. When the frame members 130 move outward in the width direction (Y) and a distance between the frame members 130 increases, the user's body, in particular the back of the head, may slip through the frame members 130, and when the distance between the frame members 130 decreases again in this state, the user may feel pain as the user's body is pressed by the frame members 130. Therefore, when the second support member 161a configured to support the user's body is provided on the upper surface of the first unit plate 161 as described above, even when the distance between the frame members 130 increases, the user's body can be prevented from slipping through, and even when an interval between the frame members 130 is adjusted, pain caused due to the user's body being pressed can be effectively prevented. Also, as the user's body is supported by the second support member 161a, the user's body may be maintained at a constant height, and constant thermal massage positions may be maintained. Further, by preventing an impact from being applied to the first unit plate 161 as the user's body slips through, a motor located at a lower portion of the first unit plate 161 can be effectively protected.

For example, the second support member 161a may be made of a synthetic resin material such as rubber, but the present invention is not necessarily limited thereto, and any other material may be used as long as the position of the material in the height direction (Z) can be fixed to prevent the user's body from slipping through.

As illustrated in FIG. 9, a curved surface 161b having a predetermined curvature to support the user's body may be provided on the first unit plate 161. When the frame members 130 move outward in the width direction (Y) and a distance between the frame members 130 increases, the user's body, in particular, the back of the neck or head, may come in contact with an end portion of the first unit plate 161, and when the curved surface 161b having a predetermined curvature to support the user's body is provided on the first unit plate 161 as described above, pain or a foreign body sensation felt by the user can be effectively prevented even when the user's body comes in contact with the first unit plate 161.

As illustrated in FIG. 1, the massage device may further include a detector 400 configured to detect positions of the pressing members 110 in the width direction (Y) and a controller 500 configured to control an operation of the interval adjusting member 120 based on a signal sent from the detector 400.

The distance between the pressing members 110 in the width direction (Y) needs to be adjusted to an interval corresponding to a part such as the cervical spine, the thoracic spine, or the lumbar spine in order to effectively perform thermal massage on the user's body, and when the detector 400 detects the positions of the pressing members 110 in the width direction (Y), and the controller 500 controls the operation of the interval adjusting member 120 based on a signal sent from the detector 400 as described above, effective thermal massage is possible for each part.

For example, although a Hall sensor may be used as the detector 400 to measure an angle of rotation of the rotary plate 121, the present invention is not limited thereto, and any other component that can detect the positions of the pressing members 110 in the width direction (Y) by measuring the angle of rotation of the rotary plate 121 may be used as the detector 400.

As described above, in the massage device in which a pressing position is adjustable in the width direction according to one embodiment of the present invention, since the distance between the pressing members 110 in the width direction (Y) can be adjusted through the interval adjusting member 120, effective thermal massage is possible for a part with a narrow interval in the width direction such as the cervical spine as well as a part with a wide interval in the width direction such as the thoracic spine or the lumbar spine, and user satisfaction is improved.

Embodiments of the present invention have been described above, but the spirit of the present invention is not limited by the embodiments presented herein, and those of ordinary skill in the art who understand the spirit of the present invention may easily propose other embodiments by adding other components, changing components, or omitting components within the scope of the same spirit. However, such embodiments also belong to the scope of the spirit of the present invention.

1. A massage device in which a pressing position is adjustable in a width direction, the massage device comprising:
a plurality of pressing members disposed to press one side and the other side of the spine of a user in the width direction; and
an interval adjusting member configured to adjust a distance between the pressing members in the width direction.

2. The massage device of claim 1, further comprising a frame member configured to provide support so that the pressing members are rotatable about a rotation axis disposed in the width direction,
wherein the interval adjusting member moves the frame member in the width direction.

3. The massage device of claim 2, wherein the interval adjusting member includes:
a rotary plate; and
a support shaft connected to the frame member and disposed at a position eccentric from a center of the rotary plate.

4. The massage device of claim 3, further comprising a fastening member fixed to the support shaft through the frame member,
wherein a through-hole through which the fastening member passes is provided in the frame member, and
an inner surface of the through-hole is disposed apart from an outer surface of the fastening member.

5. The massage device of claim 4, wherein:
an extension guide extending to surround the support shaft is provided at the frame member; and
an inner surface of the extension guide is disposed apart from an outer surface of the support shaft.

6. The massage device of claim 2, wherein:
each of the pressing members has acupressure surfaces provided on at least two or more positions in the width direction to press the user; and
the massage device further comprises an aligning member configured to maintain a constant arrangement state of the acupressure surfaces.

7. The massage device of claim 6, wherein the aligning member supports the frame member so that a constant arrangement state of the rotation axis is maintained.

8. The massage device of claim 7, wherein the aligning member includes:
a first support frame connected to the frame member disposed at one side in the width direction;
a second support frame connected to the frame member disposed at the other side in the width direction; and
a sliding bar configured to provide a path for the first support frame and the second support frame to move in the width direction.

9. The massage device of claim 8, wherein:
one side of the sliding bar in the width direction is fixed to the first support frame; and
the other side of the sliding bar in the width direction is disposed to be slidable while passing through the second support frame.

10. The massage device of claim 9, wherein:
the first support frame includes a first support housing in which a first connecting bar integrally formed with the frame member is disposed; and
the one side of the sliding bar in the width direction is fixed to the first connecting bar.

11. The massage device of claim 9, wherein:
the second support frame includes a second support housing in which a second connecting bar integrally formed with the frame member is disposed; and
the other side of the sliding bar in the width direction is slidably connected to the second connecting bar.

12. The massage device of claim 11, wherein the second support frame further includes a sliding frame disposed inside the second connecting bar to slidably support the sliding bar and having a guide surface provided to extend in the width direction of the sliding bar.

13. The massage device of claim 12, wherein an expansion guide surface extending from the guide surface to support the sliding bar from outside the second support housing is provided on the sliding frame.

14. The massage device of claim 2, wherein a first support member configured to support the user's body is provided at an inner side of the frame member in the width direction.

15. The massage device of claim 2, wherein an auxiliary pressing member configured to press the user's body is provided at an inner side of the frame member in the width direction.

16. The massage device of claim 1, wherein:
the pressing members include first acupressure tools and second acupressure tools sequentially arranged in a longitudinal direction;
a distance between the first acupressure tools in the width direction is adjusted by the interval adjusting member; and
a distance between the second acupressure tools in the width direction is fixed.

17. The massage device of claim 16, further comprising a pressing plate member on which the pressing members are disposed,
wherein the pressing plate member includes a first unit plate on which the first acupressure tools are disposed and a second unit plate on which the second acupressure tools are disposed and which is fixed to the first unit plate.

18. The massage device of claim 17, further comprising a hinge member configured to hinge and fix a rear of the pressing plate member in the longitudinal direction.

19. The massage device of claim 17, wherein a second support member configured to support the user's body is provided on an upper surface of the first unit plate.

20. The massage device of claim 17, wherein a curved surface having a predetermined curvature to support the user's body is provided on the first unit plate.

21. The massage device of claim 1, further comprising:
a detector configured to detect positions of the pressing members in the width direction; and
a controller configured to control an operation of the interval adjusting member based on a signal sent from the detector.

22. The massage device of claim 1, further comprising:
a lifting/lowering portion on which a lifting/lowering member configured to lift or lower the pressing members and a lifting/lowering driving member configured to provide a driving force of the lifting/lowering member are provided; and
a conveying portion on which a conveying plate member on which the pressing members and the lifting/lowering portion are disposed and a conveying driving member configured to provide a driving force for the conveying plate member to move in the longitudinal direction are provided.
